(19) United States
(12) Patent Application Publication
(10) Pub. No.: US 2019/0378403 A1
(43) Pub. Date: Dec. 12, 2019

(54) SMART ROAD SIGN, ELECTRONIC DEVICE, AND METHOD OF PROTECTING PEDESTRIAN USING SAME

(71) Applicant: Seung Heon SONG, Seongnam-si (KR)

(72) Inventor: Seung Heon SONG, Seongnam-si (KR)

(21) Appl. No.: 16/002,172

(22) Filed: Jun. 7, 2018

(51) Int. Cl. G08G 1/005; G08G 1/09; H04B 17/318; H04W 4/80

(52) U.S. Cl. CPC G08G 1/005; H04W 4/80; H04B 17/318; G08G 1/091

(57) ABSTRACT

Disclosed are a smart road sign, an electronic device, and a pedestrian protection method, the smart road sign transmitting a warning signal generated based on road-related information displayed on a sign, the electronic device receiving the warning signal when entering a predetermined range from the smart road sign and outputting the warning message. According to the present disclosure, it is possible to secure pedestrian safety by attracting the attention of a user of an electronic device.

### FIELD

The present disclosure relates to a smart road sign using an electronic device, an electronic device, and a method of protecting a pedestrian.

### BACKGROUND

The problem of pedestrian safety due to pedestrian or driver carelessness has become serious around the globe. For example, as reported in a document ((“Pedestrian Safety, a road safety manual for decision-makers and practitioners”, http://who.int/roadsafety/projects/manuals/pedestrian/en/) issued by the World Health Organization (WHO), more than 270,000 pedestrians lose their lives every year worldwide. Further, on the basis of documents (“Pedestrian Traffic Fatalities by State, 2016 Preliminary Data”, www.ghsa.org/sites/default/files/2017-03/2017ped_FINAL_4.pdf) issued by the Governors Highway Safety Association (GHSA) in the U.S.A. in connection with pedestrian death, the number of deaths in the U.S.A. increased by 25% from 2010 to 2015.

The recent increasing use of mobile devices by pedestrians or drivers is playing a part in this trend. When a pedestrian or a driver uses a mobile device on a road, the user is distracted and pedestrian safety significantly decreases, which results in accidents.

Accordingly, various methods of improving pedestrian safety even during the use of the mobile device have been proposed. For example, a method of providing a pedestrian with information about a road location based on GPS technology, a method of detecting and providing a change between a pavement and a road through a sensor, and a method of recognizing and providing a car image through a camera of the mobile device have been proposed. However, the conventional methods have limitations in that a location determination based on GPS has a large error, a separate sensor should be prepared, and a camera should always be activated. Accordingly, demand for a safer and more efficient pedestrian protection method increases.

### SUMMARY OF THE INVENTION

An aspect of the present disclosure is to provide a smart road sign, an electronic device, and a pedestrian protection method which can attract the attention of a user of an electronic device so as to secure pedestrian safety by generating a warning signal based on road-related information shown by a sign and transmitting the warning signal to be received by electronic devices within a predetermined range.

Another aspect of the present disclosure is to provide a smart road sign, an electronic device, and a pedestrian protection method which can efficiently transmit a warning signal through a BLE protocol and a solar panel included therein.

Another aspect of the present disclosure is to provide a smart road sign, an electronic device, and a pedestrian protection method which can attract the attention of a user of an electronic device as the electronic device transmits a warning message based on the warning signal received from the smart road sign.

In accordance with an aspect of the present disclosure, a smart road sign is provided. The smart road sign includes: a support; a sign supported by the support and configured to show road-related information; and a signal transmission device installed in one area of the sign and configured to transmit a warning signal based on the road-related information, wherein the signal transmission device includes a power supplier, a memory configured to store a protocol used for transmission of the warning signal, a controller configured to control generation and transmission of the warning signal based on the protocol stored in the memory, and a signal transmitter configured to transmit the warning signal with a strength that can be received by electronic devices within a predetermined range under the control of the controller.

The road-related information may include information related to road conditions at the location at which the smart road sign is installed, information related to pedestrian safety, or information related to car driving.

The warning signal may include identification information and location information of the smart road sign, the road-related information, and the transmission strength of the warning signal.

The protocol may include a Bluetooth Low Energy (BLE) protocol.

The warning signal may include a data packet in a BLE-Unique Identifier (UID) type.

The signal transmission device may further include an antenna for transmitting the warning signal in a particular direction.

The power supplier may include a solar panel.

In accordance with another aspect of the present disclosure, an electronic device is provided. The electronic device includes: a wireless communication unit; an output unit; and a controller configured to receive a warning signal transmitted from a smart road sign through the wireless communication unit, calculate a distance to the smart road sign based on the warning signal, generate a warning message based on the calculated distance, road-related information included in the warning signal, and identification information and location information of the smart road sign, and output the generated warning message through the output unit.

The controller may calculate the distance to the smart road sign based on a warning signal transmission strength included in the warning signal and a Received Signal Strength Indicator (RSSI) of the warning signal.

The output unit may include a display, and the controller may overlappingly display the warning message on a screen displayed on the display.

The output unit may include a sound output unit and a haptic module, and the controller may output the warning message in the form of a voice through the sound output unit or in the form of vibration through the haptic module.

The controller may receive at least one piece of map information and traffic information according to location information of the smart road sign from an external network connected to the wireless communication unit and output the received information through the output unit.

In accordance with another aspect of the present disclosure, a method of protecting a pedestrian using a smart road sign and an electronic device is provided. The method includes: generating a warning signal based on road-related information displayed on the smart road sign and a protocol used for transmission of the warning signal; transmitting the warning signal with a strength that can be received by electronic devices within a predetermined range; receiving the warning signal transmitted from the smart road sign; calculating a distance to the smart road sign based on the warning signal; generating a warning message based on the calculated distance, the road-related information included in the warning signal, and identification information and location information of the smart road sign; and outputting the generated warning message.

As described above, the present disclosure may provide a smart road sign, an electronic device, and a pedestrian protection method which can attract the attention of a user of an electronic device so as to secure pedestrian safety by generating a warning signal based on road-related information shown by a sign and transmitting the warning signal to be received by electronic devices within a predetermined range.

The present disclosure may provide a smart road sign, an electronic device, and a pedestrian protection method which can efficiently transmit a warning signal through a BLE protocol and a solar panel included therein.

The present disclosure may provide a smart road sign, an electronic device, and a pedestrian protection method which can attract the attention of a user of an electronic device as the electronic device transmits a warning message based on the warning signal received from the smart road sign.

### DRAWINGS

The above and other aspects, features and advantages of the present disclosure will be more apparent from the following detailed description taken in conjunction with the accompanying drawings, in which:

FIG. 1 schematically illustrates a pedestrian protection system using a smart road sign and an electronic device according to the present disclosure;

FIG. 2 is a block diagram illustrating a signal transmission device included in a smart road sign according to the present disclosure;

FIGS. 3 and 4 illustrate a Bluetooth Low Energy protocol related to transmission of a warning signal according to the present disclosure;

FIGS. 5 and 6 illustrate an antenna and a solar panel included in a signal transmission device according to the present disclosure;

FIG. 7 is a block diagram illustrating an electronic device receiving a warning signal transmitted from a smart road sign according to the present disclosure;

FIGS. 8 to 11 illustrate that the electronic device receiving the warning signal outputs a warning message according to the present disclosure;

FIGS. 12 and 13 illustrate that the electronic device receiving the warning signal outputs map information received from an external network according to the present disclosure;

FIG. 14 is a flowchart illustrating a pedestrian protection method using a smart road sign and an electronic device according to the present disclosure;

FIGS. 15 and 16 illustrate an experimental result of a distance between the smart road sign and the electronic device which receives the warning signal transmitted from the smart road sign according to the present disclosure;

FIGS. 17 and 18 illustrate an experimental result indicating whether the pedestrian can stop near a target line on the basis of whether an application for receiving the warning signal is activated according to the present disclosure; and

FIGS. 19 to 21 illustrate an experimental result of a strength of the warning signal which is transmitted from the smart road sign and received by an electronic device within a moving vehicle according to the present disclosure.

### DETAILED DESCRIPTION

Hereinafter, embodiments of the present disclosure will be described in detail with reference to the accompanying drawings. In designating elements of the drawings by reference numerals, the same elements will be designated by the same reference numerals although they are shown in different drawings. Further, in the following description of the present disclosure, a detailed description of known functions and configurations incorporated herein will be omitted when it may make the subject matter of the present disclosure rather unclear.

In addition, terms, such as first, second, A, B, (a), (b) or the like may be used herein when describing components of the present disclosure. These terms are merely used to distinguish one structural element from other structural elements, and a property, an order, a sequence and the like of a corresponding structural element are not limited by the term. It should be noted that if it is described in the specification that one component is “connected,” “coupled” or “joined” to another component, a third component may be “connected,” “coupled,” and “joined” between the first and second components, although the first component may be directly connected, coupled or joined to the second component.

Electronic devices described in the present disclosure may include mobile phones, smart phones, Personal Digital Assistants (PDA), Portable Multimedia Players (PMP), navigation devices, tablet Personal Computers (PC), and wearable devices (for example, a watch-type terminal (smart watch), a glasses-type terminal (smart glasses), and a Head-Mounted Display (HMD)).

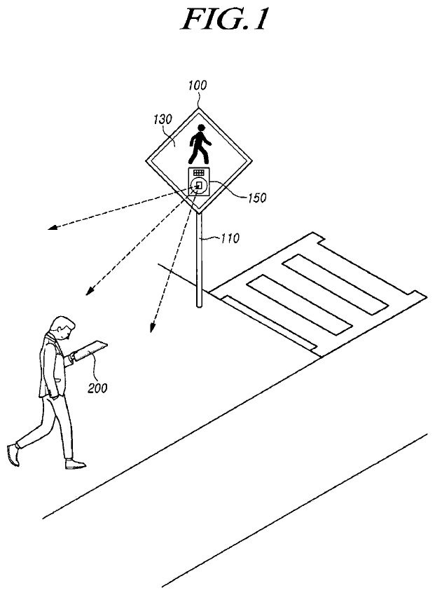

FIG. 1 schematically illustrates a pedestrian protection system using a smart road sign and an electronic device according to the present disclosure.

Referring to FIG. 1, a smart road sign 100 is installed in an area at an intersection. The smart road sign 100 may include a support 110, a sign 130 supported by the support to show information related to the road, and a signal transmission device 150 installed in the area of the sign to transmit a warning signal on the basis of the information related to the road.

The sign 130 indicates information related to the road depending on the sign type. The information related to the road may include information related to road conditions at the location at which the smart road sign 100 is installed, information related to walking of a pedestrian, or information related to driving of a car. For example, the information related to the road may include information indicating that the road is under construction, information indicating that there is a crosswalk, or information on a speed limit on the road.

According to an embodiment, it is assumed that the road sign 130 of FIG. 1 shows information related to the road indicating that there is a crosswalk ahead. However, this is only an example, and a sign to which embodiments of the present disclosure are applied is not limited to a particular type. When a pedestrian can be protected by a warning signal transmitted from the smart road sign, the content of the present disclosure can be substantially equally applied to any sign.

Referring to FIG. 1, the pedestrian walks while viewing the screen of the electronic device 200. In some cases, the pedestrian may enter the road without watching the end of the pavement since the pedestrian is distracted by the use of the electronic device 200.

According to an embodiment of the present disclosure, the signal transmission device 150 included in the smart road sign 100 may generate a warning signal on the basis of information related to the road shown on the sign 130. For example, according to the assumption, the signal transmission device 150 may generate a warning signal including information indicating that there is a crosswalk ahead.

The signal transmission device 150 may transmit the generated warning signal. According to an embodiment, the warning signal may be transmitted in a forward direction. Alternatively, according to another embodiment, the warning signal may be transmitted with directivity. For example, the warning signal may be controlled to be mainly transmitted in the direction from which the pedestrian is coming.

According to an embodiment, the warning signal may be transmitted with a strength that many unspecified electronic devices within a predetermined range (r) from the smart road sign 100 can receive. That is, the warning signal may be received by unspecified electronic devices that enter the predetermined range (r), rather than being transmitted after a communication connection with a particular electronic device. In this case, it is natural for the electronic device 200 to include hardware or software for receiving the warning signal.

Referring back to FIG. 1, when the pedestrian enters the predetermined range (r), the electronic device 200 may receive the warning signal transmitted from the smart road sign 100. A controller of the electronic device 200 may generate a warning message to be provided to the pedestrian on the basis of the transmitted warning signal. The pedestrian may pay attention due to the warning message output from the electronic device 200 and thus be made aware of the road and the crosswalk ahead.

That is, it is possible to secure pedestrian safety by generating the warning signal on the basis of information related to the road shown by the sign, transmitting the warning signal that can be received by the electronic device within a predetermined range, and attracting the attention of the user of the electronic device.

Hereinafter, the smart road sign and the electronic device included in the pedestrian protection system will be described in detail with reference to the relevant drawings.

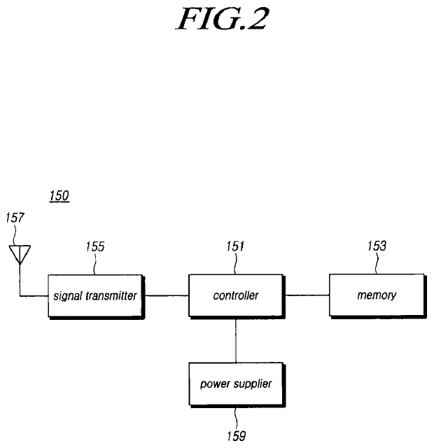

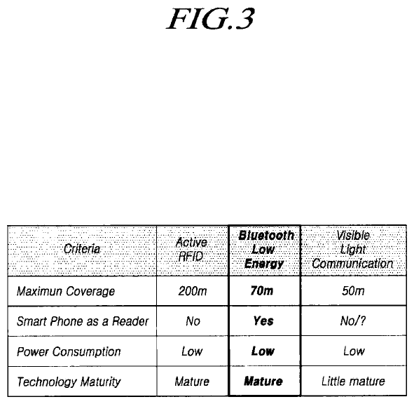

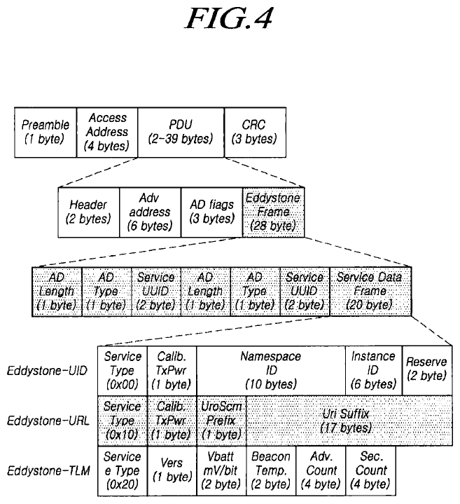

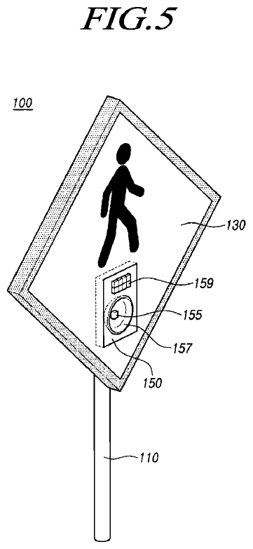

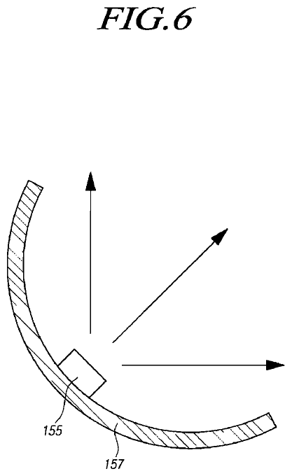

FIG. 2 is a block diagram illustrating a signal transmission device included in a smart road sign according to the present disclosure. FIGS. 3 and 4 illustrate a Bluetooth Low Energy protocol related to transmission of a warning signal according to the present disclosure. FIGS. 5 and 6 illustrate an antenna and a solar panel included in a signal transmission device according to the present disclosure.

Referring to FIG. 2, the signal transmission device 150 may include a power supplier 159, a memory 153 for storing a protocol used for transmission of the warning signal, a controller 151 for controlling generation and transmission of the warning signal on the basis of the protocol stored in the memory, and a signal transmitter 155 for transmitting the warning signal with a strength that electronic devices within a predetermined range can receive under the control of the controller. According to an embodiment, the signal transmission device 150 may further include an antenna 157.

The memory 153 may store information related to transmission of the warning signal. The memory 153 may store information related to the road shown on the sign 130. The memory 153 may store the protocol used for transmission of the warning signal. The memory 153 may store identification information of the smart road sign 100 and location information on the location at which the smart road sign 100 is installed.

The controller 151 may control the overall operation of the signal transmission device 150 through each element of the signal transmission device 150. The controller 151 may generate the warning signal on the basis of information stored in the memory 153. Generation and transmission of the warning signal may be performed according to the protocol stored in the memory 153.

The warning signal may be generated to include identification information and location information of the smart road sign 100, information related to the road, and the transmission strength of the warning signal. According to an embodiment, a Bluetooth Low Energy (BLE) protocol may be used for generation and transmission of the warning signal.

Referring to FIG. 3, as technology that can be used for transmission of the warning signal by the smart road sign 100, active RFID, Bluetooth Low Energy, and visible light communication, which are already known, are described. A general smart phone may have difficulty in receiving the active RFID, and thus a separate device may be required. Further, in the case of visible light communication, there may exist a similar problem, and it may take a long time to apply visible light communication since it is at a technically immature stage. Accordingly, it may be preferable to transmit the warning signal through Bluetooth Low Energy technology.

According to an embodiment of the present disclosure, the controller 151 may generate the warning signal through a data packet in a BLE-Unique Identifier (BLE-UID) type based on the BLE protocol. Referring to FIG. 4, an example of a packet structure of a BLE advertisement message using the known BLE protocol is illustrated. As illustrated in FIG. 4, the BLU-UID packet includes 16-byte data on an ID of a device which transmits the BLE-UID packet together with controlled TxPower information. The device ID is divided into a Namespace ID (10 bytes) and an Instance ID (6 bytes).

According to an embodiment, a Namespace area included in the BLE-UID data packet may include location information of the smart road sign 100. Through 10 bytes allocated to the Namespace area, the controller 151 may insert an ISO national code, a postal code, and additional unique identification information into the warning signal. For example, the Namespace area may include a total of twenty characters, including three digits corresponding to the ISO national code, ten alphabet letters and digits corresponding to the postal code, and seven characters corresponding to the additional unique identification information.

According to an embodiment, the Instance area included in the BLE-UID data packet may include road-related information of the smart road sign 100. Through 6 bytes allocated to the Instance area, the controller 151 may insert the type of the road sign and information of the road sign into the warning signal. For example, the Instance area may include a total of twelve characters, such as three alphabet letters and digits corresponding to the type of the road sign and nine characters corresponding to the information of the road sign.

However, this is only an example, and the present disclosure is not limited thereto. The information included in the Namespace area and the Instance area and the size of the data assigned to each piece of information may be set differently as necessary. Further, the BLE-UID data type illustrated in FIG. 4 is only an example, and the present disclosure is not limited thereto. If the information required for generation of the warning signal can be included, another type of BLE-UID data packet can be used, without limitation to a particular type.

Referring back to FIG. 2, the signal transmitter 155 may transmit the warning signal generated by the controller 151 to the outside under the control of the controller 151. The transmission strength of the warning signal may be set in advance. For example, in a first mode for a pedestrian's electronic device, the warning signal may be set to be transmitted with a strength of 0 dBm (decibels above 1 milliwatt) at an interval of 540 ms (milliseconds). Further, in a second mode for a driver's electronic device, the warning signal may be set to be transmitted with a strength of 4 dBm at an interval of 100 ms.

The antenna 157 may be included in the signal transmission device 150 so as to transmit the warning signal in a particular direction. For example, the antenna 157 may be implemented in a parabolic antenna type. The signal transmitter 155 may be disposed within the antenna 157. For example, the memory 153, the controller 151, and the signal transmitter 155 may be implemented as a single module.

Referring to FIG. 5, the signal transmission device 150 installed in the area of the sign 130 of the smart road sign 100 is illustrated. It can be seen that the signal transmitter 155 is disposed within the antenna 157. FIG. 6 is a cross-sectional view schematically illustrating the antenna 157 and the signal transmitter 155 illustrated in FIG. 5. The warning signal transmitted from the signal transmitter 155 may be reflected from a reflective surface of the antenna 157 and transmitted in a particular direction. Accordingly, the omnidirectionally transmitted warning signal may be intensively transmitted in a particular direction.

For example, in the first mode, a Received Signal Strength Indicator (RSSI) may be measured at a distance of 3 m while the warning signal is transmitted with a strength of 0 dBm at an interval of 540 ms. While the average RSSI is measured as 73.0 dBm when the parabolic antenna is not installed, the average RSSI is measured as −64.5 dBm when the parabolic antenna is installed. That is, it can be seen that the RSSI in a particular direction is larger due to the installation of the parabolic antenna.

The power supplier 159 may supply power required for the operation of each element of the signal transmission device 150 under the control of the controller 151. The power supplier 159 may include a battery, and the battery may be a rechargeable battery.

According to an embodiment, the power supplier 159 may include a solar panel, as illustrated in FIG. 5. The power supplier 159 may include a connection port, and the connection port may be electrically connected to the solar panel to charge the battery. By charging the battery through electric energy collected by the solar panel, the energy can be efficiently used.

Although it has been described that the memory 153, the controller 151, the signal transmitter 155, the antenna 157, and the power supplier 159 are separate elements, the signal transmission device 150 may be implemented as a single module according to an embodiment. In this case, the smart road sign 100 may be implemented in a form in which the signal transmission device 150 is combined with the existing road sign.

That is, it is possible to secure pedestrian safety by generating the warning signal on the basis of information related to the road shown by the sign, transmitting the warning signal, which can be received by the electronic device within a predetermined range, and attracting the attention of the user of the electronic device. Further, through the BLE protocol and the solar panel, the warning signal can be efficiently transmitted.

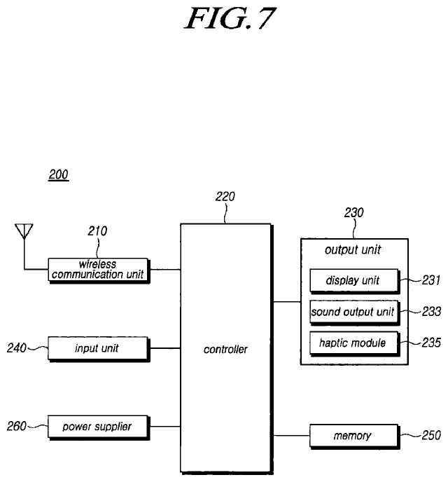

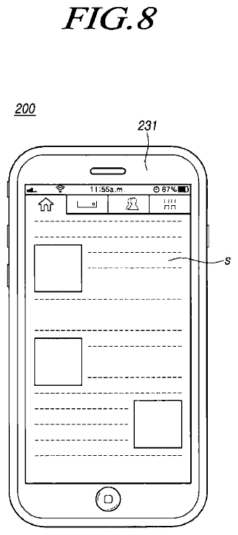

FIG. 7 is a block diagram illustrating an electronic device receiving a warning signal transmitted from a smart road sign according to the present disclosure. FIGS. 8 to 11 illustrate that the electronic device receiving the warning signal outputs a warning message according to the present disclosure.

Referring to FIG. 7, the electronic device 200 may include a wireless communication unit 210, an output unit 230, and a controller 220 for receiving a warning signal transmitted from a smart road sign through the wireless communication unit, calculating a distance from the smart road sign on the basis of the warning signal, generating a warning message on the basis of the calculated distance, road-related information included in the warning signal, and identification information and location information of the smart road sign, and outputting the generated warning message through the output unit.

The wireless communication unit 210 may include a broadcast reception module for receiving a broadcast signal and/or broadcast-related information from an external broadcast management server, a mobile communication module for transmitting/receiving a wireless signal according to a communication scheme for mobile communication, a wireless Internet module for wireless Internet access, a location information module for acquiring the location of an electronic device, or a short-range communication module for short-range communication.

The short-range communication module included in the wireless communication unit 210 may support short-range communication through BLE technology. When the electronic device 200 approaches the smart road sign 100 within a predetermined range, the electronic device 200 may receive the warning signal through the wireless communication unit 210.

The output unit 230 generates visual, auditory, or tactile output, and may include a display unit 231, a sound output unit 233, or a haptic module 235. The display unit 231 may display screens of applications executed in the electronic device 200. When the display unit 231 is implemented as a touch screen, the display unit 231 may act as an input unit 240 for receiving a touch input from the user.

The sound output unit 233 may output audio data received from the wireless communication unit 210 or stored in the memory 250. The sound output unit 152 may output a sound signal related to a function performed by the electronic device 200.

The haptic module 235 generates various tactile effects that the user can feel. A representative example of the tactile effects generated by the haptic module 235 may be vibration. The strength and the pattern of the vibration generated by the haptic module 235 may be controlled by a user's selection or settings of the controller 220.

The controller 220 controls the overall operation of the electronic device 200. The controller 220 may provide or process information or functions suitable for the user by processing signals, data, and information input or output through the above-described elements or driving an application stored in the memory 250.

The controller 220 may receive the warning signal transmitted from the smart road sign 100 through the wireless communication unit 210. According to an example, the controller 220 may execute an application for receiving the warning signal. The application for receiving the warning signal may identify whether a BLE-based warning signal is received. Even when another application is being executed in the foreground according to a pedestrian's selection, the controller 220 may execute the application for receiving the warning signal in the background.

The controller 220 may calculate the distance from the smart road sign 100 on the basis of the warning signal. According to an example, the controller 220 may calculate the distance from the smart road sign 100 on the basis of a warning signal transmission strength included in the warning signal and the RSSI of the warning signal. The controller 220 may calculate the distance through a loss value in the transmission strength when the warning signal is transmitted. Since this is known technology, a more detailed description will be omitted.

The controller 220 may generate the warning message on the basis of the calculated distance, the road-related information included in the warning signal, and identification information and location information of the smart road sign. The controller 220 may extract the road-related information and the identification information and location information of the smart road sign 100 from the BLE-UID data packet.

The controller 220 may generate the warning message on the basis of the extracted data. For example, when the road-related information indicating that there is a crosswalk ahead is extracted, the controller 220 may generate the warning message indicating that there is a crosswalk ahead. The warning message may be generated in the form of visual data, auditory data, or tactile data.

The controller 220 may output the generated warning message through the output unit 230. Referring to FIG. 8, an execution screen (s) of an application selected by the pedestrian may be displayed on the display unit 231 of the electronic device 200. It is assumed that the pedestrian is walking while viewing the execution screen (s).

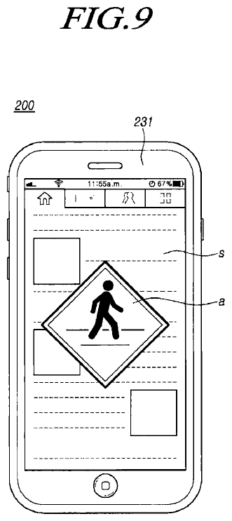

The controller 220 may display the warning message (a) generated in the form of visual data on the display unit 231, as illustrated in FIG. 9. According to an example, the warning message (a) may be overlappingly displayed on the execution screen (s). Although FIG. 9 illustrates the sign of the smart road sign 100 transmitting the warning signal as a warning message (a), this is only an example, and the present disclosure is not limited thereto. According to another example, the warning message (a) may be implemented in characters, figures, or symbols that can attract the user's attention.

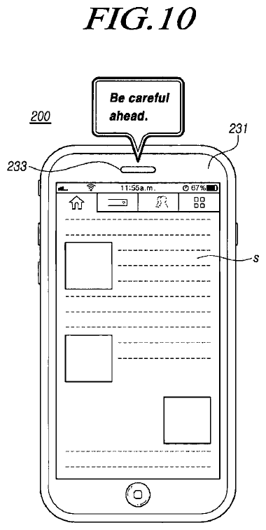

Further, the controller 220 may output the warning message generated in the form of auditory data through the sound output unit 233, as illustrated in FIG. 10. According to an example, the warning message may be implemented in the form of voice data that explains the content of the sign of the smart road sign 100 transmitting the warning signal. However, this is only an example, and the present disclosure is not limited thereto. According to another example, the warning message may be implemented in the form of sound data that can attract the user's attention.

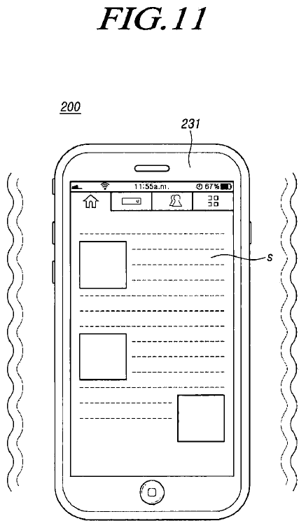

Further, the controller 220 may output the warning message generated in the form of tactile data through the haptic module 235, as illustrated in FIG. 11. According to an embodiment, the warning message may be implemented as vibration performed a predetermined number of times and according to a predetermined pattern.

That is, because the electronic device outputs the warning message on the basis of the warning signal received from the smart road sign, it is possible to attract the attention of the user of the electronic device.

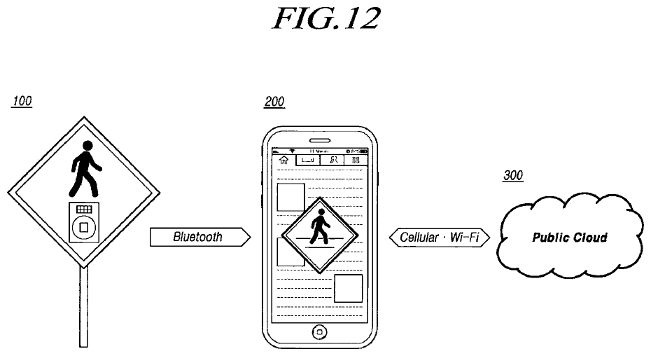

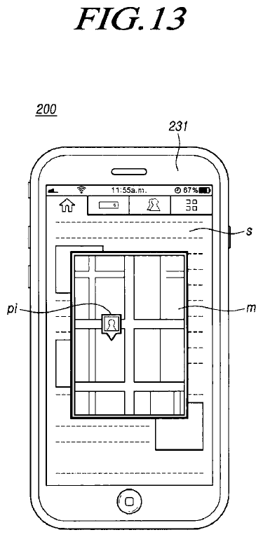

FIGS. 12 and 13 illustrate that the electronic device receiving the warning signal outputs map information received from an external network according to the present disclosure.

Referring to FIG. 12, the electronic device 200 may receive the warning signal according to the BLE protocol from the smart road sign 100. Further, the electronic device 200 may be connected to an external network 300 for communication therewith through the wireless communication unit 210. The controller 220 may receive at least one piece of map information and traffic information according to location information of the smart road sign 100 from the external network 300.

The controller 220 may output the received information through the output unit 230. Referring to FIG. 13, map information (m) may be overlappingly displayed on the execution screen (s) of the application displayed on the display unit 231. The location (pi) of the pedestrian using the electronic device 200 may be displayed on the map information (m). The location of the smart road sign 100 may also be displayed.

Accordingly, map information or traffic information may be conveniently identified on the basis of the warning signal received from the smart road sign.

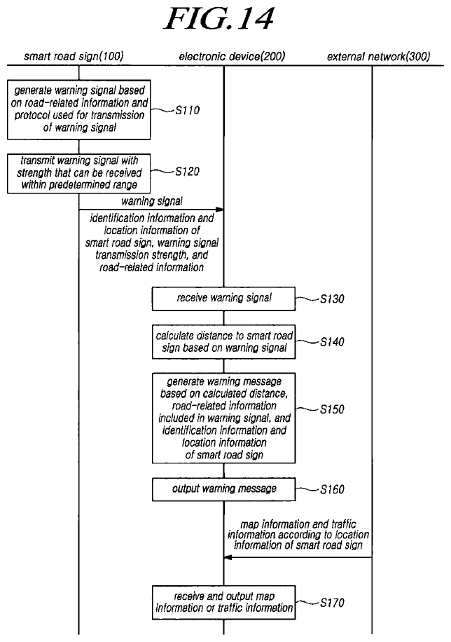

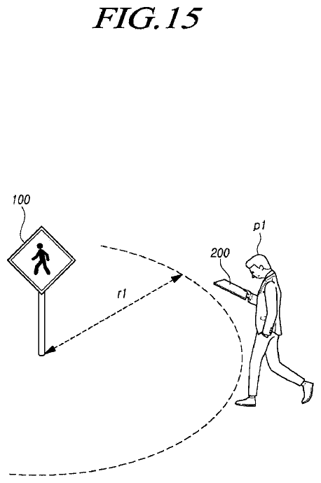

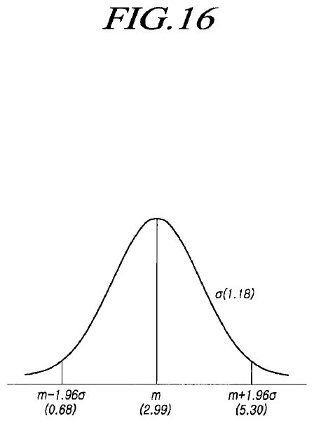

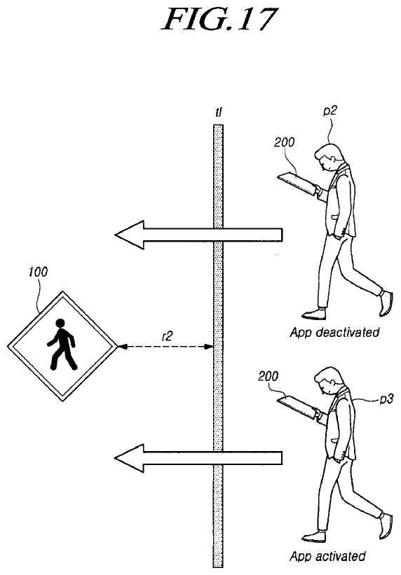

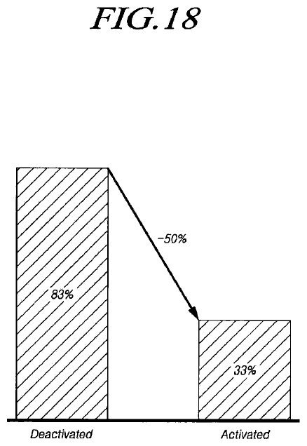

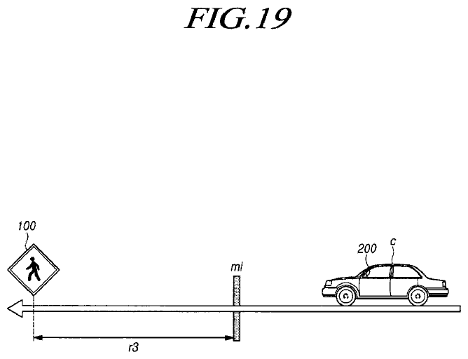

FIG. 14 is a flowchart illustrating a pedestrian protection method using a smart road sign and an electronic device according to the present disclosure. FIGS. 15 and 16 illustrate an experimental result of a distance between the smart road sign and the electronic device which receives the warning signal transmitted from the smart road sign according to the present disclosure. FIGS. 17 and 18 illustrate an experimental result indicating whether the pedestrian can stop near a target line on the basis of whether an application for receiving the warning signal is activated according to the present disclosure. FIGS. 19 to 21 illustrate an experimental result of the strength of the warning signal which is transmitted from the smart road sign and received by an electronic device within a moving car according to the present disclosure.

The pedestrian protection method according to the present disclosure may be implemented using the smart road sign 100 and the electronic device 200. Hereinafter, the pedestrian protection method according to an embodiment of the present disclosure and the operation of the smart road sign 100 and the electronic device 200 for implementing the pedestrian protection method will be described in detail with reference to the drawings as necessary.

Referring to FIG. 14, the smart road sign 100 may generate the warning signal on the basis of road-related information shown by the sign of the smart road sign 100 and the protocol used for transmission of the warning signal in S110.

The smart road sign 100 may generate the warning signal on the basis of information stored in the memory. The generation and transmission of the warning signal may be performed according to the protocol stored in the memory. The warning signal may be generated to include identification information and location information of the smart road sign 100, information related to the road, and the transmission strength of the warning signal. According to an example, a BLE protocol may be used for generation and transmission of the warning signal.

The smart road sign 100 may generate the warning signal through a BLE-UID data packet according to the BLE protocol. A Namespace area included in the BLE-UID data packet may include location information of the smart road sign 100. Through 10 bytes allocated to the Namespace area, the controller 151 may insert an ISO national code, a postal code, and additional unique identification information into the warning signal. For example, the Namespace area may include a total of twenty characters, including three digits corresponding to the ISO national code, ten alphabet letters and digits corresponding to the postal code, and seven characters corresponding to the additional unique identification information.

According to an example, the Instance area included in the BLE-UID data packet may include road-related information of the smart road sign 100. Through 6 bytes allocated to the Instance area, the controller 151 may insert the type of the road sign and information of the road sign into the warning signal. For example, the Instance area may include a total of twelve characters, including three alphabet letters and digits corresponding to the type of the road sign and nine characters corresponding to the information of the road sign.

However, this is only an example, and the present disclosure is not limited thereto. The information included in the Namespace area and the Instance area and the size of the data assigned to each piece of information may be differently set as necessary.

Referring back to FIG. 14, the smart road sign 100 may transmit the warning signal with a strength that electronic devices within a predetermined range can receive in S120.

The transmission strength of the warning signal may be set in advance. The warning signal may be transmitted with a strength that many unspecified electronic devices within a predetermined range from the smart road sign 100 can receive. For example, in a first mode for the electronic device of the pedestrian, the warning signal may be set to be transmitted with a strength 0 dBm (decibels above 1 milliwatt) at an interval of 540 ms (milliseconds). Further, in a second mode for a driver's electronic device, the warning signal may be set to be transmitted with a strength of 4 dBm at an interval of 100 ms.

Referring to FIG. 15, a pedestrian (p1) holding the electronic device 200 approaches the smart road sign 100, and the distance (r1) at which the warning signal is received is measured. When the warning signal is transmitted in the first mode (in which the warning signal is transmitted with a strength of 0 dBm at an interval of 540 ms), the distance to the smart road sign 100 is measured at the time point at which the electronic device 200 receives the warning signal. This is an experiment to determine the strength at which a warning signal should be transmitted in order to be effective in influencing the pedestrian. Of course, the application for receiving the warning signal is activated in the electronic device 200.

Referring to FIG. 16, in a total of 115 repeated experimental trials, the mean and the standard deviation of distances measured when an initial warning signal is received are illustrated. That is, it can be seen that the warning signal is received, on average, 2.99 m before the warning signal is transmitted in the first mode. The standard deviation according thereto is calculated as 1.18. When the warning signal is received approximately 3 m beforehand, the pedestrian can identify the warning signal and stop walking, as desired, and thus the first mode may be determined as a preferable transmission mode.

However, this is only an example, and the present disclosure is not limited thereto. It is natural that the warning signal can be set to be transmitted with different time intervals and different strengths according to the conditions under which the smart road sign 100 is installed.

Further, the smart road sign 100 may further include an antenna for transmitting the warning signal in a particular direction. According to an example, the antenna may be implemented in a parabolic antenna type. The signal transmitter for transmitting the warning signal may be disposed within the antenna. The warning signal transmitted by the signal transmitter may be reflected from a reflective surface of the antenna and transmitted in a particular direction. Accordingly, the omnidirectionally transmitted warning signal may be intensively transmitted in a particular direction.

Referring back to FIG. 14, the electronic device 200 may receive the warning signal transmitted from the smart road sign in S130.

The electronic device 200 may receive the warning signal transmitted from the smart road sign 100 through the wireless communication unit. According to an example, the electronic device 200 may execute the application for receiving the warning signal. The application for receiving the warning signal may identify whether a BLE-based warning signal is received. Even when another application is being executed in the foreground according to a pedestrian's selection, the controller 200 may execute the application for receiving the warning signal in the background.

Referring back to FIG. 14, the electronic device 200 may calculate the distance to the smart road sign on the basis of the warning signal in S140.

The electronic device 200 may calculate the distance to the smart road sign 100 on the basis of the warning signal. According to an example, the electronic device 200 may calculate the distance to the smart road sign 100 on the basis of the warning signal transmission strength included in the warning signal and the RSSI of the warning signal. The electronic device 200 may calculate the distance through a loss value in the transmission strength when the warning signal is transmitted.

Referring back to FIG. 14, the electronic device 200 may generate the warning message on the basis of the calculated distance, road-related information included in the warning signal, and identification information and location information of the smart road sign in S150.

The electronic device 200 may extract the road-related information and the identification information and location information of the smart road sign 100 from the BLE-UID data packet included in the warning signal. The electronic device 200 may generate the warning message through the extracted data. For example, when road-related information indicating that there is a crosswalk ahead is extracted, the electronic device 200 may generate the warning message indicating that there is a crosswalk ahead. The warning message may be generated in the form of visual data, auditory data, or tactile data.

Referring back to FIG. 14, the electronic device 200 may output the generated warning message in S160.

The electronic device 200 may output the generated warning message through the output unit. The electronic device 200 may display the warning message generated in the form of visual data on the display unit. According to an example, as the warning message, the sign of the smart road sign 100 transmitting the warning signal may be displayed, but this is only an example, and the present disclosure is not limited thereto. According to another example, the warning message may be implemented in characters, figures, or symbols that can attract the user's attention.

Further, the electronic device 200 may output the warning message generated in the form of auditory data through the sound output unit. According to an example, the warning message may be implemented in the form of voice data that explains the content of the sign of the smart road sign 100 transmitting the warning signal. However, this is only an example, and the present disclosure is not limited thereto. According to another example, the warning message may be implemented in the form of sound data that can attract the user's attention.

Further, the electronic device 200 may output the warning message generated in the form of tactile data through the haptic module. According to an example, the warning message may be implemented as vibration performed a predetermined number of times and according to a predetermined pattern.

Referring to FIG. 17, two groups of pedestrians (p2 and p3) approach the smart road sign 100 while viewing the screen of the electronic device 200. In the electronic device 200 of the pedestrian group (p2), the application for receiving the warning signal is deactivated. Conversely, in the electronic device 200 of the pedestrian group (p3), the application for receiving the warning signal is activated.

The pedestrian group (p2) is required to stop when the pedestrian group (p2) approaches close to a target line (t1) during walking while viewing the screen of the electronic device 200. The pedestrian group (p3) is required to stop when the pedestrian group (p3) receives the warning from the smart road sign 100 located at a predetermined distance (r2) from the target line (t1) during walking while viewing the screen of the electronic device 200.

The signal transmission device of the smart road sign 100 is set to transmit the warning signal with a strength of 0 dBm at an interval of 540 ms in the first mode. In this case, it is measured whether the pedestrian who walks while viewing the electronic device 200 crosses the target line (t1). This is an experiment to find whether the transmission of the warning signal has the effect of attracting the pedestrian's attention.

Referring to FIG. 18, experimental results for the pedestrian group (p2), in which the application for receiving the warning signal is deactivated, and the pedestrian group (p3) in which the application for receiving the warning signal is activated, are illustrated. It can be seen that 83% of pedestrians who walk while viewing the electronic device 200 in which the application for receiving the warning signal is deactivated cross the target line (t1). Further, only 33% of pedestrians who walk while viewing the electronic device 200 in which the application for receiving the warning signal is activated cross the target line (t1). That is, according to transmission and reception of the warning signal, there is a protective effect of attracting the attention of a pedestrian viewing an electronic device.

Referring to FIG. 19, a car (c) driven by a driver using the electronic device 200 approaches the smart road sign 100. At a location spaced apart from the smart road sign 100 by a predetermined distance (r3), a measurement line (m1) on which the RSSI of the warning signal is measured is set.

The signal transmission device of the smart road sign 100 is set to transmit the warning signal with a strength of 4 dBm at an interval of 100 ms in the second mode. The driver is required to measure the RSSI of the warning signal on the measurement line (m1) while driving the car (c) at a speed of 0, 10, 20, 30, or 40 mph (mile per hour). The measurement is repeated 20 times at each speed. This is an experiment to find whether a moving car can effectively receive the warning signal.

In this case, according to an example, the electronic device 200 may be a mobile device used by the driver. Alternatively, according to another example, the electronic device 200 may be an electronic device such as a navigation device installed in the car (c).

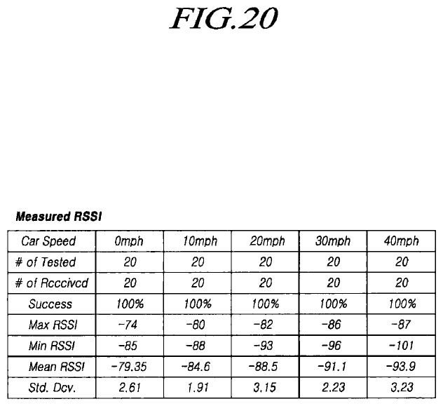

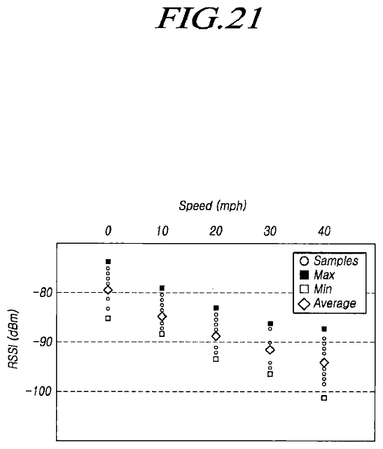

FIG. 20 shows the probability of reception of the warning signal at each speed, as well as the maximum value, minimum value, mean, and standard deviation of the RSSI measured at each speed. It can be seen that warning signals transmitted in the second mode are all received at each speed. However, as illustrated in the graph of FIG. 21, it can be seen that the RSSI decreases as the car speed increases.

Referring back to FIG. 14, the electronic device 200 may receive map information or traffic information from the external network 300 and output the received map information or traffic information in S170.

The electronic device 200 may be connected with the external network 200 for communication therewith through the wireless communication unit. The electronic device 200 may receive at least one piece of the map information and the traffic information according to location information of the smart road sign 100 from the external network 300.

The electronic device 200 may output the received information through the output unit. The electronic device 200 may display the map information or the traffic information on the display unit. The location of the pedestrian using the electronic device 200 may be displayed on the map information. The location of the smart road sign 100 may also be displayed. Accordingly, based on the warning signal received from the smart road sign, map information or traffic information may be conveniently identified.

That is, it is possible to secure pedestrian safety by generating the warning signal on the basis of information related to the road shown by the sign, transmitting the warning signal which can be received by the electronic device within a predetermined range, and attracting the attention of the user of the electronic device.

The present disclosure can be implemented by computer-readable code in a medium on which a program is recorded. The computer-readable medium includes all types of recording devices which store data readable by a computer system. For example, the computer-readable medium includes a Hard Disk Drive (HDD), a Solid-State Disk (SSD), a Silicon Disk Drive (SDD), ROM, RAM, a CD-ROM, a magnetic tape, a floppy disc, an optical data storage device, and the like, and also includes an implementation in the form of a carrier wave (for example, transmission over the Internet).

The above description and the accompanying drawings provide an example of the technical idea of the present disclosure for illustrative purposes only. Those having ordinary knowledge in the technical field, to which the present disclosure pertains, will appreciate that various modifications and changes in form, such as combination, separation, substitution, and change of a configuration, are possible without departing from the essential features of the present disclosure. Therefore, the embodiments disclosed in the present disclosure are intended to illustrate the scope of the technical idea of the present disclosure, and the scope of the present disclosure is not limited by the embodiment. That is, at least two elements of all structural elements may be selectively joined and operate without departing from the scope of the present disclosure. The scope of the present disclosure shall be construed on the basis of the accompanying claims in such a manner that all of the technical ideas included within the scope equivalent to the claims belong to the present disclosure.

What is claimed is:

1. A smart road sign comprising:
a support;
a sign supported by the support and configured to show road-related information; and
a signal transmission device installed in one area of the sign and configured to transmit a warning signal based on the road-related information,
wherein the signal transmission device comprises a power supplier, a memory configured to store a protocol used for transmission of the warning signal, a controller configured to control generation and transmission of the warning signal based on the protocol stored in the memory, and a signal transmitter configured to transmit the warning signal with a strength that can be received by electronic devices within a predetermined range under a control of the controller.

2. The smart road sign of claim 1, wherein the road-related information includes information related to a road condition at a location at which the smart road sign is installed, information related to pedestrian safety, or information related to car driving.

3. The smart road sign of claim 1, wherein the warning signal includes identification information and location information of the smart road sign, the road-related information, and a transmission strength of the warning signal.

4. The smart road sign of claim 1, wherein the protocol includes a Bluetooth Low Energy (BLE) protocol.

5. The smart road sign of claim 4, wherein the warning signal includes a data packet in a BLE-Unique Identifier (UID) type.

6. The smart road sign of claim 1, wherein the signal transmission device further comprises an antenna for transmitting the warning signal in a particular direction.

7. The smart road sign of claim 1, wherein the power supplier comprises a solar panel.

8. An electronic device comprising:
a wireless communication unit;
an output unit; and
a controller configured to receive a warning signal transmitted from a smart road sign through the wireless communication unit, calculate a distance to the smart road sign based on the warning signal, generate a warning message based on the calculated distance, road-related information included in the warning signal, and identification information and location information of the smart road sign, and output the generated warning message through the output unit.

9. The electronic device of claim 8, wherein the controller calculates the distance to the smart road sign based on a warning signal transmission strength included in the warning signal and a Received Signal Strength Indicator (RSSI) of the warning signal.

10. The electronic device of claim 8, wherein the output unit comprises a display, and the controller overlappingly displays the warning message on a screen displayed on the display.

11. The electronic device of claim 8, wherein the output unit comprises a sound output unit and a haptic module, and the controller outputs the warning message in a form of a voice through the sound output unit or in a form of vibration through the haptic module.

12. The electronic device of claim 8, wherein the controller receives at least one piece of map information and traffic information according to location information of the smart road sign from an external network connected to the wireless communication unit and outputs the received information through the output unit.

13. A method of protecting a pedestrian using a smart road sign and an electronic device, the method comprising:
generating a warning signal based on road-related information displayed on the smart road sign and a protocol used for transmission of the warning signal;
transmitting the warning signal with a strength that can be received by electronic devices within a predetermined range;
receiving the warning signal transmitted from the smart road sign;
calculating a distance to the smart road sign based on the warning signal;
generating a warning message based on the calculated distance, the road-related information included in the warning signal, and identification information and location information of the smart road sign; and
outputting the generated warning message.

14. The method of claim 13, wherein the road-related information includes information related to a road condition at a location at which the smart road sign is installed, information related to pedestrian safety, or information related to car driving.

15. The method of claim 13, wherein the protocol includes a Bluetooth Low Energy (BLE) protocol.

16. The method of claim 15, wherein the warning signal includes a data packet in a BLE-Unique Identifier (UID) type.

17. The method of claim 13, wherein the transmitting the warning signal comprises transmitting the warning signal in a particular direction through an antenna.

18. The method of claim 13, wherein the warning signal further includes a warning signal transmission strength, and the calculating of the distance to the smart road sign comprises calculating the distance to the smart road sign based on the warning signal transmission strength included in the warning signal and a Received Signal Strength Indicator (RSSI) of the warning signal.

19. The method of claim 13, wherein the outputting of the generated warning message comprises overlappingly displaying the warning message on a screen displayed on a display.

20. The method of claim 13, further comprising receiving at least one piece of map information and traffic information based on the smart road sign from an external network and outputting the received information.
